(19) United States
(12) Patent Application Publication
(10) Pub. No.: US 2005/0231099 A1
(43) Pub. Date: Oct. 20, 2005

(54) Luminescence brightness compensation structure of field-emission display

(76) Inventors: Wei-Sheng Hsu, Guanyin Township (TW); Chi-Hung Hsiao, Guanyin Township (TW)

Correspondence Address: Yi-Wen Tseng, 4331 Stevens Battle Lane, Fairfax, VA, 22033, US

(21) Appl. No.: 10/934,579

(22) Filed: Sep. 3, 2004

(30) Foreign Application Priority Data
Apr. 14, 2004 (TW) 093110353

(51) Int. Cl. H05B 33/00

(52) U.S. Cl. 313/496

(57) ABSTRACT

A luminescent brightness compensator of a field-emission display has three primary colors cathode conductive layers arranged at various levels according to the respective luminescent efficiencies thereof. Thereby, the color (blue) has the lowest luminescent efficiency gains a strong electric field to the anode electrode, such that more electrons are drained to generate this color light. Therefore, the different luminescent efficiency of three primary colors is compensated, and a better color image can be obtained.

### BACKGROUND OF THE INVENTION

The present invention relates in general to a compensation structure of luminescent brightness of a field-emission display, and more particularly, to a field-emission display of which the electric field between the anode and electrode is adjusted according to the luminescent efficiency.

The field-emission display is a very newly developed technology. Being self-illuminant, such type of display does not require a back light source like the liquid crystal display (LCD). In addition to the better brightness, the viewing angle is broader, power consumption is lower, response speed is faster (no residual image), and the operation temperature range is larger. The image quality of the field-emission display is similar to that of the conventional cathode ray tube (CRT) display, while the dimension of the field-emission display is much thinner and lighter compared to the cathode ray tube display. Therefore, it is foreseeable that the field-emission display may replace the liquid crystal display in the market. Further, the fast growing nanotechnology enables nano-material to be applied in the field-emission display, such that the technology of field-emission display will be commercially available.

FIG. 1 shows a cross sectional view of a basic tripolar field-emission display. The anode plate 10 and the cathode plate 20 are supported by a spacer 14. The anode plate 10 includes an anode substrate 11, an anode conductive layer 12 and a phosphor layer 13. The cathode plate 20 includes a cathode substrate 21, a cathode conductive layer 22, an electron-emission source layer 23, a dielectric layer 24 and a gate layer 25. The gate layer 25 is subjected to a potential difference to drain electrons from the electron-emission source layer 23. The high voltage provided by the anode conductive layer 12 accelerates the beam of electrons with energy kinetic energy to impinge the phosphor layer 13 of the anode plate 10, so as to generate light.

The display includes a plurality of pixels composed of red, blue and green cathode and anode units. The composition difference of the phosphor layer 13 provides three primary colors; however, the primary color light generated provided by the phosphor have different luminescent efficiencies. As a result, although the electron beam generated from the electron-emission source layer of each cathode and anode unit has the same kinetic energy, or the same electrons are generated from the electron-emission source layer of each, the brightness of the light generated from the phosphor layer of the unit is different. Typically, the brightness ratio of the red, blue and green color light is about 2:1:7. Therefore, color or brightness distortion often occurs. By the conventional structure as disclosed in FIG. 1, a delicate and complex control circuit is required to compensate or offset the inconsistent luminescent efficiencies. It is thus very uneconomic.

Another approach to resolve the discrepancies in luminescent efficiencies is to adjust the thickness or area of the phosphor layer 13. The drawback of such approach is that the number of pixels is so numerous that it is not very difficult to make the thickness of the phosphor layer 13 for the same color identical.

### BRIEF SUMMARY OF THE INVENTION

A luminescent brightness compensating structure for a field-emission display is provided allowing the differences in luminescent efficiencies for various colors to be offset with the same conditions of electron beam. In addition, the compensating structure does not require complex circuit or process, such that the cost is greatly reduced.

The luminescent brightness compensating structure includes a cathode conductive layer at different levels according to the luminescent efficiency of the color of the phosphor layer, such that the distance between the electron-emission layer of the cathode plate and the phosphor layer for various colors is adjusted the same. As a result, different electric fields are driven for the cathode and anode units according to the color of the phosphor layer. Therefore, the discrepancies of luminescent efficiencies for different colors can be offset.

### BRIEF DESCRIPTION OF THE DRAWINGS

The above objects and advantages of the present invention will be become more apparent by describing in detail exemplary embodiments thereof with reference to the attached drawings in which:

FIG. 1 is a cross sectional view of a conventional tripolar field-emission display; and

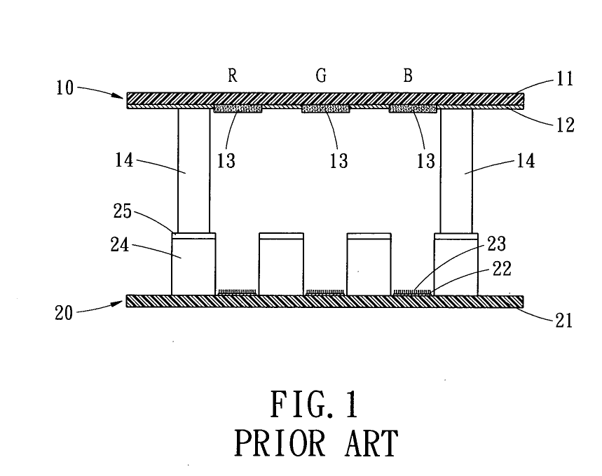

FIG. 2 is a cross sectional view of an embodiment of a field-emission display according to the present invention.

### DETAILED DESCRIPTION OF THE INVENTION

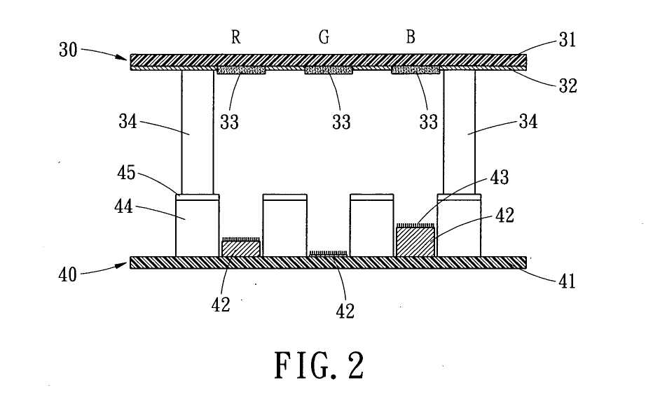

Referring to FIG. 2, as provided, the field-emission display as provided has a tripolar structure, including an anode plate 40, a cathode plate 30 and a spacer 34 extending between the anode plate 40 and the cathode plate 30. The anode plate 30 includes an anode substrate 31, an anode conductive layer 32 and a phosphor layer 33. The cathode plate 40 includes a cathode substrate 41, a cathode conductive layer 42, an electron-emission layer 43, a dielectric layer 44 and a gate layer 45. The phosphor layer 33 is patterned to form a plurality of red, green and blue anode units as shown in FIG. 2, while the electron-emission layer 43 and the cathode conductive layers 42 are patterned to form a plurality of cathode units between which the patterned dielectric layer 44 and the gate layer 45 are formed. As shown, each anode unit is aligned with a cathode unit, and the cathode units are isolated by the patterned dielectric layer 44 and driven by the surrounding gate layer 45 on top of the dielectric layer 44. As mentioned above, the luminescent efficiency ratio for the green, red and blue light is 7:2:1. Therefore, in this embodiment, the distance between the electron-emission source layer 43 and the green, red and blue phosphor layer is 7:2:1, such that the electric field for the pair of anode and cathode units for green, red and red colors is 1/7:1/2:1, that is, 2:7:14. According to the relationship between the electric field E, distance D and potential V (E=V/D), the electric fields multiplied by the luminescent efficiencies for the green, red and blue colors become 1:1:1. As a result, various numbers of electrons are generated from the electron-emisison source layer 43 according to the colors of the phosphor layer 33, and a uniform brightness is obtained. The difference in luminescent efficiencies is thus compensated. Stronger electric fields are driven for the colors such as blue and red having lower luminescent efficiencies, the brightness of the blue and red colors is thus enhanced. Currently, the available technology allows the distance between the gate layer 45 and the electron-emission source layer 43 reaches about 2:1:1 for blue, green and red colors. It is foreseeable that the brightness compensation can be optimized if the distance between the gate layer 45 and the electron-emission source layer 43 can be adjusted to 7:2:1 for the three primary colors. Further, the embodiment uses three primary colors as an example to obtain a full-color image, it will be appreciated that the distance between phosphor layer and the electron-emission source layer may be adjusted differently should the phosphor layer is selected from those colors other than green, red and blue.

In the embodiment as shown in FIG. 2, the levels of the electron-emission layer 43 are adjusted by forming the cathode conductive layer 42 with various heights or thickness. The method for fabricating the cathode conductive layer 42 with various thicknesses can be achieved by various processes.

For example, the thick-film process can be applied. By screen-printing multiple layers of silver paste, the cathode conductive layer 42 can be formed with a thickness determined by the number of layers of the silver paste.

Another example for forming the cathode conductive layer 42 includes photolithography process. A photosensitive silver paste is used as the material for forming the cathode conductive layer 42. By performing exposure on the silver paste with different exposure time, the height or thickness of the resulting cathode conductive layer 42 can be adjusted.

By either the thick-film process or photolithography process, the thickness or height of the cathode conductive layer can be precisely controlled. Therefore, the complex control circuit or complex process is not required. The brightness compensation can be achieved with the least cost.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. A luminescent brightness compensating structure, comprising at least:
a pair of a green phosphor layer and a first unit of electron emission source unit spaced from the green phosphor layer by a first distance;
a pair of a red phosphor layer and a second unit of electron emission source spaced from the red phosphor layer by a second distance; and
a third pair of a blue phosphor layer and the a third unit of electron emission source spaced from the blue phosphor layer by a third distance; wherein
the first, second and third distances are adjusted according to luminescent efficiencies of the green, red and blue phosphor layers.

2. The structure of claim 1, wherein the ratio of the first, second, and third distances is 1/7:1/2:1.

3. The structure of claim 1, further comprising at least three gate layers adjacent to the first, second and third units of electron emission sources.

4. The structure of claim 3, wherein the gate layers are level between the green, red and blue phosphor layers and the first, second and third units of electron emission sources.

5. The structure of claim 3, wherein the distance ratio between the green, red and blue phosphor layers and the corresponding gate layers is about 2:1:1.

6. A luminescent brightness compensation structure for a field-emission display, comprising a plurality sets of green, red and blue pixels, wherein each of the pixels has a phosphor layer and an electron emission source layer, and the distances between the phosphor layers and the electron emission layers for the green, red and blue pixels are different according to luminescent efficiencies thereof.

7. The structure of claim 6, wherein the distance ratio of the phosphor layers and the electron emission layers of the green, red and blue pixels is about 7:2:1.

8. The structure of claim 6, wherein each of the pixels further comprising a cathode conductive layer on which the electron emission layer is formed, and an anode conductive layer on which the phosphor layer is formed.

9. The structure of claim 7, wherein the cathode conductive layers for the green, red and blue pixels have different thickness.

10. The structure of claim 7, wherein the cathode conductive layers comprises multiple layers of silver paste.

11. The structure of claim 7, wherein the cathode conductive layer includes multiple layers of screen-printed silver paste.

12. The structure of claim 7, wherein the cathode conductive layer is fabricated with various thicknesses by photolithography process.

13. The structure of claim 6, wherein each of the pixels further comprising a gate layer adjacent to the electron emission layer and level between the electron layer and the phosphor layer.

14. The structure of claim 6, wherein each of the pixels further comprising a dielectric layer between the electron emission layers of the adjacent pixels.

15. The structure of claim 14, wherein each of the pixels further comprising a gate layer formed on the dielectric layer.

16. A field-emission display, comprising:
an anode plate, comprising a plurality of red, blue and green phosphor layers; and
a cathode plate, comprising a plurality of electron emission source units aligned with the corresponding phosphor layers, wherein the electron emission source units are spaced from the corresponding phosphor layers by distances determined by the luminescent efficiencies of the corresponding phosphor layers.

17. The display of claim 16, further comprising a spacer extending between the anode plate and the cathode plate.

18. The display of claim 16, wherein the anode plate further comprising an anode conductive layer on which the red, green and blue phosphor layers are formed.

19. The display of claim 17, wherein the anode plate further comprising a substrate on which the conductive layer and the red, green and blue phosphor layers are formed.

20. The display of claim 17, wherein the cathode plate further comprising a plurality of cathode conductive layers on which the electron emission layers are formed.

21. The display of claim 17, wherein the cathode conductive layers include multiple layers of silver paste.

22. The display of claim 17, wherein the cathode conductive layers include silver paste formed with various thicknesses.

23. The display of claim 17, wherein the cathode plate further comprises a patterned dielectric layer to separate adjacent electron emission layers.

24. The display of claim 23, wherein the cathode plate further comprises a patterned gate layer formed on the patterned dielectric layer.

25. The display of claim 24, wherein the distance between the gate layer and the electron emission adjacent thereto is determined according to the luminescent efficiency of the corresponding phosphor layer.
